(19) United States
(12) Patent Application Publication
(10) Pub. No.: US 2020/0096318 A1
(43) Pub. Date: Mar. 26, 2020

(54) THICKNESS MEASURING APPARATUS AND GRINDING APPARATUS INCLUDING THE SAME

(71) Applicant: DISCO CORPORATION, Tokyo (JP)

(72) Inventors: Nobuyuki KIMURA, Tokyo (JP); Taiki SAWABE, Tokyo (JP); Keiji NOMARU, Tokyo (JP)

(21) Appl. No.: 16/567,109

(22) Filed: Sep. 11, 2019

(30) Foreign Application Priority Data
Sep. 21, 2018 (JP) 2018-177684

(51) Int. Cl. G01B 11/06; B24B 49/12

(52) U.S. Cl. CPC G01B 11/06; B24B 49/12

(57) ABSTRACT

A thickness measuring apparatus measures the thickness of a wafer. The apparatus includes a light source for emitting light having a transmission wavelength region to the wafer, a focusing unit for applying the light emitted from the light source to the wafer, a first optical path for optically connecting the light source to the focusing unit, an optical branching section provided on the first optical path for branching the light reflected on the wafer and then guiding the reflected light to a second optical path, a diffraction grating provided on the second optical path for diffracting the reflected light to obtain diffracted light of different wavelengths, an image sensor for detecting the intensity of the diffracted light according to the different wavelengths and producing a spectral interference waveform, and a control unit having a thickness computing section for computing the spectral interference waveform to output thickness information.

### BACKGROUND OF THE INVENTION

### Field of the Invention

The present invention relates to a thickness measuring apparatus for measuring the thickness of a wafer and also to a grinding apparatus including the thickness measuring apparatus.

### Description of the Related Art

A plurality of devices such as integrated circuits (ICs) and large-scale integrated circuits (LSIs) are formed on the front side of a wafer so as to be separated from each other by a plurality of crossing division lines. The backside of the wafer having the plural devices on the front side is ground by a grinding apparatus to thereby reduce the thickness of the wafer. Thereafter, the wafer is divided along the division lines by a dicing apparatus or a laser processing apparatus to obtain individual device chips. The device chips thus obtained are used in various electrical equipment such as mobile phones and personal computers.

The grinding apparatus for grinding the back side of the wafer includes a chuck table for holding the wafer, a grinding unit having a rotatable grinding wheel for grinding the wafer held on the chuck table, and a thickness measuring apparatus for measuring the thickness of the wafer held on the chuck table, whereby the thickness of the wafer can be reduced to a desired thickness.

As a thickness measuring apparatus, there is a contact type measuring apparatus using a probe adapted to come into contact with the work surface of the wafer, thereby measuring the thickness of the wafer. However, when such a contact type measuring apparatus is used, the work surface (backside) of the wafer may be damaged by the probe. To cope with this problem, a noncontact type measuring apparatus is conventionally used (see Japanese Patent Laid-open No. 2012-021916, Japanese Patent Laid-open No. 2018-036212, and Japanese Patent Laid-open No. 2018-063148). The noncontact type measuring apparatus is configured so that light is applied to the work surface of the wafer and a spectral interference waveform is produced from the light reflected on the work surface of the wafer and the light transmitted through the wafer and reflected on the other surface opposite to the work surface, thereby measuring the thickness of the wafer.

### SUMMARY OF THE INVENTION

The measurement of the thickness of the wafer will now be described in the case of using such a noncontact type measuring apparatus using a spectral interference wave form as described in the above publications. In this case, the wafer has a two-layer structure composed of an LN substrate (700 μm) as an upper layer and an SiO₂ film (3 μm or less) as a lower layer in the condition where the wafer is held on the chuck table. That is, the SiO₂ film is formed on the lower surface (device forming surface) of the LN substrate, and the thickness of the SiO₂ film is relatively much less than the thickness of the LN substrate. First, light having a transmission wavelength to the wafer is applied to the back side of the wafer, that is, to the upper surface of the wafer, thereby obtaining reflected light from the wafer. This reflected light is diffracted by a diffraction grating included in the thickness measuring apparatus to obtain diffracted light of different wavelengths, thereby producing a spectral interference waveform W0 (see FIG. 6A).

Thereafter, waveform analysis using Fourier transform or the like is performed to the spectral interference waveform W0, thereby obtaining signal intensity waveforms X (a), X (b), and X (a+b) as depicted in FIG. 6B. Further, according to the peak position in each waveform, an optical path difference, or thickness information is obtained. More specifically, the thickness (a) of the LN substrate is obtained from the interference light between the reflected light from the upper surface of the LN substrate and the reflected light from the lower surface of the LN substrate. Further, the thickness (b) of the SiO₂ film is obtained from the interference light between the reflected light from the lower surface of the LN substrate and the reflected light from the lower surface of the SiO₂ film. Further, the thickness (a+b) of the LN substrate+the SiO₂ film is obtained from the interference light between the reflected light from the upper surface of the LN substrate and the reflected light from the lower surface of the SiO₂ film. However, in the case that the thickness (b) of the SiO₂ film is 3 μm, which is much less than the thickness of the LN substrate, the signal intensity waveform X (a) indicating the thickness (a) of the LN substrate is synthesized with the signal intensity waveform X (a+b) indicating the thickness (a+b) of the LN substrate+the SiO₂ film to obtain X (S) as depicted in FIG. 6B. Accordingly, there is a problem that the thickness (a) of the LN substrate alone cannot be accurately detected.

It is therefore an object of the present invention to provide a thickness measuring apparatus which can measure with high accuracy the thickness of a wafer composed of plural layers.

It is another object of the present invention to provide a grinding apparatus including this thickness measuring apparatus.

In accordance with an aspect of the present invention, there is provided a thickness measuring apparatus for measuring the thickness of a wafer, the thickness measuring apparatus including a light source for emitting light having a transmission wavelength region to the wafer; focusing means applying the light emitted from the light source to the wafer held on a chuck table, the wafer being composed of an A-layer as an upper layer and a B-layer as a lower layer in the condition where the wafer is held on the chuck table; a first optical path for optically connecting the light source to the focusing means; an optical branching section provided on the first optical path for branching the light reflected on the wafer held on the chuck table and then guiding the reflected light to a second optical path; a diffraction grating provided on the second optical path for diffracting the reflected light to obtain diffracted light of different wavelengths; an image sensor for detecting the intensity of the diffracted light according to the different wavelengths and producing a spectral interference waveform; and a control unit having a thickness computing means computing the spectral interference waveform produced by the image sensor to output thickness information; the thickness computing means including a thickness deciding section having a theoretical waveform table on which a plurality of theoretical spectral interference waveforms to be formed by the pass of the light through the A-layer and the B-layer of the wafer are recorded in a plurality of areas defined by changing the thickness of the A-layer and the thickness of the B-layer, the thickness deciding section comparing the spectral interference waveform produced by the image sensor with the theoretical spectral interference waveforms recorded in the theoretical waveform table, determining whether or not the spectral interference waveform coincides with any one of the theoretical spectral interference waveforms, and deciding as proper thicknesses the thicknesses of the A-layer and the B-layer corresponding to the theoretical spectral interference waveform coinciding with the spectral interference waveform.

Preferably, the thickness computing means further includes a thickness calculating section for performing Fourier transform to the spectral interference waveform produced by the image sensor and calculating at least the thickness of the A-layer, the thickness of the B-layer, and the thickness of the A-layer+the B-layer, the A-layer and the B-layer constituting the wafer.

Preferably, when the thickness computing means determines that the thickness of the A-layer calculated by the thickness calculating section is included in the thickness range of the A-layer recorded in the theoretical waveform table of the thickness deciding section, the thickness of the A-layer decided as the proper thickness by the thickness deciding section is used as the thickness of the A-layer.

In accordance with another aspect of the present invention, there is provided a grinding apparatus including the thickness measuring apparatus mentioned above for grinding the A-layer of said wafer held on the chuck table to thereby reduce the thickness of the wafer, the control unit further including a finished thickness setting section for setting a target finished thickness of the A-layer; where after the thickness of the A-layer calculated by the thickness calculating section has reached the thickness range of the A-layer recorded in the theoretical waveform table of the thickness deciding section, the thickness computing means compares the spectral interference waveform produced by the image sensor with the theoretical spectral interference waveform recorded in the theoretical wave form table, this theoretical spectral interference waveform corresponding to the target finished thickness of the A-layer as set in the finished thickness setting section, next determines whether or not the spectral interference waveform coincides with the theoretical spectral interference waveform, and next ends the grinding of the wafer when the spectral interference waveform coincides with the theoretical spectral interference waveform.

According to the thickness measuring apparatus of the present invention, the following effect can be exhibited in measuring the thickness of a wafer having a two-layer structure composed of the A-layer (upper layer) and the B-layer (lower layer), the thickness of the B-layer being relatively much less than the thickness of the A-layer. A plurality of interference waves are produced by the diffraction grating in the thickness measuring apparatus. The reflected light from the upper surface of the A-layer and the reflected light from the lower surface of the A-layer interfere with each other to produce an interference wave and accordingly obtain the thickness information on the A-layer. Further, the reflected light from the upper surface of the A-layer and the reflected light from the lower surface of the B-layer interfere with each other to produce another interference wave and accordingly obtain the thickness information on the A-layer+the B-layer. The thickness information on the A-layer is synthesized with the thickness information on the A-layer+the B-layer, so that there may be a problem that the thickness of the A-layer alone cannot be detected. However, this problem can be solved by deciding the thickness of the A-layer using the thickness deciding section. That is, the thickness of the A-layer alone can be measured.

Further, according to the grinding apparatus including the thickness measuring apparatus of the present invention, the following effect can be exhibited. When the thickness of the A-layer reduced by grinding has reached the predetermined thickness range recorded in the theoretical waveform table included in the thickness deciding section, the thickness computing means compares the spectral interference waveform produced by the image sensor with the theoretical spectral interference waveform recorded in the theoretical wave form table, this theoretical spectral interference waveform corresponding to the target finished thickness of the A-layer as set in the finished thickness setting section. When the spectral interference waveform coincides with the theoretical spectral interference waveform, it is determined that the thickness of the A-layer has reached the target finished thickness and the grinding operation is ended. Accordingly, even when the wafer has a two-layer structure, the A-layer of the wafer can be ground to obtain a desired finished thickness. Further, since the thickness measuring apparatus of the present invention is of a noncontact type, there is no possibility that the upper surface of the wafer (the upper surface of the A-layer) may be damaged by the thickness measuring apparatus in measuring the thickness of the wafer.

The above and other objects, features, and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is an overall perspective view of a grinding apparatus according to a preferred embodiment of the present invention and a perspective view of a wafer to be ground by the grinding apparatus;

FIG. 2 is a schematic diagram depicting an optical system configuring a thickness measuring apparatus included in the grinding apparatus depicted in FIG. 1;

FIG. 3A is a graph depicting a spectral interference wave form produced by a thickness calculating section included in the thickness measuring apparatus depicted in FIG. 2;

FIG. 3B is a graph depicting waveforms of signal intensity by the waveform analysis of the spectral interference waveform depicted in FIG. 3A for obtaining an optical path difference;

FIG. 4A is a theoretical waveform table stored in a thickness deciding section included in the thickness measuring apparatus depicted in FIG. 2;

FIG. 4B is a graph depicting a spectral interference waveform produced according to a detection signal from an image sensor included in the thickness measuring apparatus depicted in FIG. 2;

FIG. 5 is a perspective view depicting a condition where the wafer is ground by the grinding apparatus depicted in FIG. 1;

FIG. 6A is a graph depicting a spectral interference waveform produced by an image sensor in the prior art; and

FIG. 6B is a graph depicting waveforms of signal intensity by the waveform analysis of the spectral interference waveform depicted in FIG. 6A for obtaining an optical path difference.

### DETAILED DESCRIPTION OF THE PREFERRED EMBODIMENT

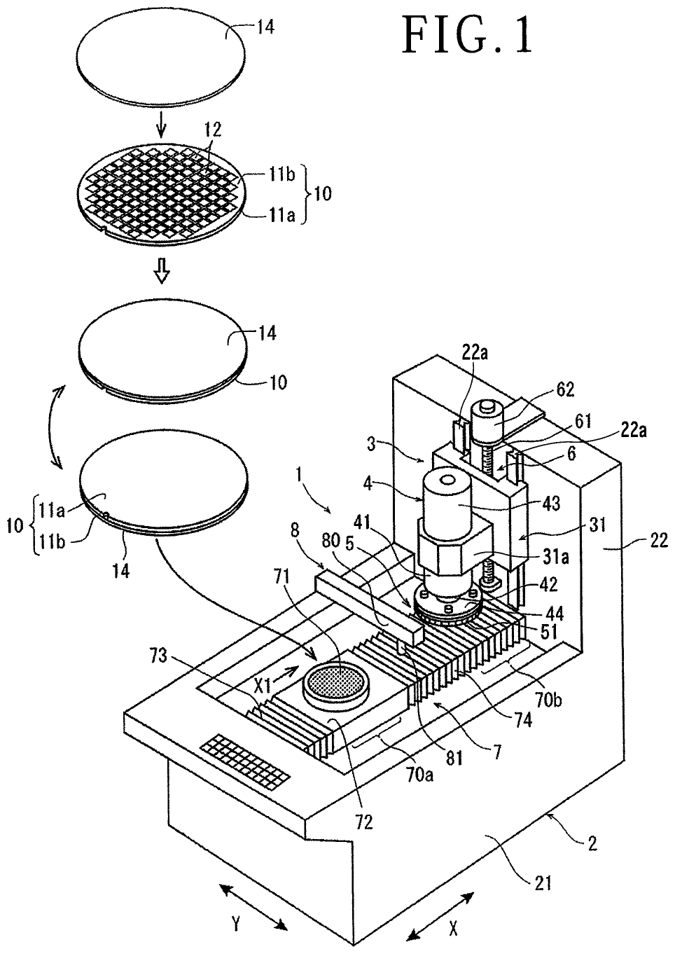

There will now be described in detail a thickness measuring apparatus according to a preferred embodiment of the present invention and a grinding apparatus including the thickness measuring apparatus with reference to the attached drawings. FIG. 1 is an overall perspective view depicting a grinding apparatus 1 including a thickness measuring apparatus 8 according to this preferred embodiment. FIG. 1 also depicts a wafer 10 as a workpiece whose thickness is to be measured by the thickness measuring apparatus 8 in the present embodiment.

The wafer 10 has, for example, a two-layer structure composed of an LN (lithium niobate) substrate 11a having devices 12 on one side and an SiO₂ (silicon oxide) film 11b as an insulating film formed on the one side of the LN substrate 11a where the devices 12 are formed. Thus, the wafer 10 has a front side and a back side opposite to the front side, where the front side of the wafer 10 is the side where the devices 12 are formed and the SiO₂ film 11b is formed as an insulating film, and the back side of the wafer 10 is the same side as the other side of the LN substrate 11a to be ground by the grinding apparatus 1. In this preferred embodiment, the thickness of the wafer 10 before grinding is such that the LN substrate 11a has a thickness of approximately 100 μm and the SiO₂ film 11b has a thickness of approximately 0.3 μm, where the thickness of the LN substrate 11a and the thickness of the SiO₂ film 11b are previously grasped.

The grinding apparatus 1 depicted in FIG. 1 includes a base housing 2. The base housing 2 has a main portion 21 having a shape like a rectangular prism and a vertical wall 22 extending upward from the rear end of the main portion 21 (the right upper end as viewed in FIG. 1). A grinding unit 3 is vertically movably mounted on the front surface of the vertical wall 22.

The grinding unit 3 includes a movable base 31 and a spindle unit 4 mounted on the movable base 31. A pair of parallel guide rails 22a is provided on the front surface of the vertical wall 22 so as to extend vertically, and the movable base 31 is slidably engaged with the guide rails 22a. A support portion 31a projects from the front surface of the movable base 31, and the spindle unit 4 is fixed to the support portion 31a. Thus, the spindle unit 4, as a grinding unit, is mounted through the support portion 31a to the movable base 31.

The spindle unit 4 includes a spindle housing 41, a vertically extending spindle 42 rotatably supported to the spindle housing 41, and a servo motor 43 as a drive source for rotationally driving the spindle 42. The spindle 42 has one end portion (lower end portion as viewed in FIG. 1) projecting from the lower end of the spindle housing 41. A wheel mount 44 is provided at the lower end of the spindle 42. A grinding wheel 5 is mounted on the lower surface of the wheel mount 44. A plurality of abrasive members (segments) 51 are fixed to the lower surface of the grinding wheel 5.

The grinding apparatus 1 further includes a grinding unit feeding mechanism 6 for vertically moving the grinding unit 3 along the pair of guide rails 22a. The grinding unit feeding mechanism 6 includes an externally threaded rod 61 provided on the front side of the vertical wall 22 so as to extend substantially vertically and a pulse motor 62 as a drive source for rotationally driving the externally threaded rod 61. A nut portion (not depicted) is provided on the rear surface of the vertical wall 31 so as to engage with the externally threaded rod 61. Accordingly, when the pulse motor 62 is normally operated to rotate the externally threaded rod 61 in a forward direction, the movable base 31 is lowered, that is, the grinding unit 3 is lowered, whereas when the pulse motor 62 is reversely operated to rotate the externally threaded rod 61 in a backward direction, the movable base 31 is raised, that is, the grinding unit 3 is raised.

A chuck table mechanism 7 as holding means for holding the wafer 10 is provided on the main portion 21 of the base housing 2. The chuck table mechanism 7 includes a chuck table 71, a cover member 72 surrounding the outer circumference of the chuck table 71, and a pair of bellows 73 and 74 connected to the front and rear ends of the cover member 72. The chuck table 71 has an upper surface (holding surface) for holding the wafer 10 thereon under suction by operating suction means (not depicted). The chuck table 71 is configured rotatable about its vertical axis by rotational drive means (not depicted). Further, the chuck table 71 is movable back and forth in the X direction depicted by an arrow X in FIG. 1 by a chuck table moving mechanism (not depicted). More specifically, the chuck table 71 is movable between a standby position 70a depicted in FIG. 1 where the wafer 10 is placed on the chuck table 71 and a grinding position 70b where the wafer 10 held on the chuck table 71 is opposed to the grinding wheel 5 (the abrasive members 51).

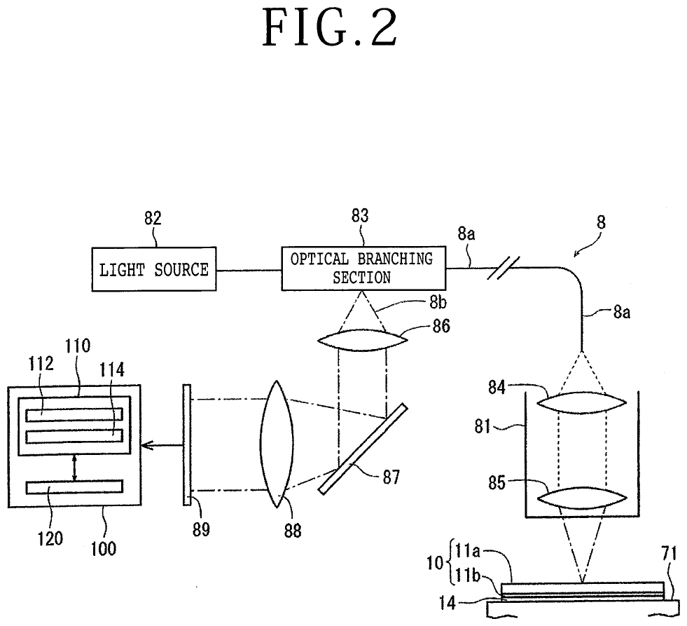

All of the servo motor 43, the pulse motor 62, the rotational drive means for the chuck table 71, the chuck table moving mechanism and the like (not depicted) are controlled by a control unit 100 (see FIG. 2) which will be hereinafter described. The outer circumference of the wafer 10 is formed with a notch for indicating crystal orientation, in the present embodiment. A protective tape 14 as a protective member is attached to the front side of the wafer 10. The wafer 10 with the protective tape 14 is held on the chuck table 71 in the condition where the protective tape 14 is in contact with the upper surface (holding surface) of the chuck table 71, that is, in the condition where the back side of the wafer 10 is oriented upward (i.e., the LN substrate 11a is oriented upward).

The thickness measuring apparatus 8 included in the grinding apparatus 1 functions to measure the thickness of the wafer 10 held on the chuck table 71. The thickness measuring apparatus 8 includes a housing 80. As depicted in FIG. 1, the housing 80 is movably mounted at its base end portion on the upper surface of the main portion 21 of the base housing 2 at a position between the standby position 70a and the grinding position 70b. The thickness measuring apparatus 8 is movable in the X direction. Accordingly, the thickness of the wafer 10 held on the chuck table 71 can be measured from above by the thickness measuring apparatus 8 located between the standby position 70a and the grinding position 70b. Focusing means 81 is provided on the lower surface of the housing 80 at its front end portion. The focusing means 81 is adapted to face the wafer 10 held on the chuck table 71. The focusing means 81 is movable back and forth in the Y direction depicted by an arrow Y in FIG. 1 by driving means (not depicted). FIG. 2 depicts an optical system configuring the thickness measuring apparatus 8. This optical system will now be described in detail with reference to FIG. 2.

As depicted in FIG. 2, the optical system configuring the thickness measuring apparatus 8 includes a light source 82 for emitting light having a predetermined transmission wavelength region to the wafer 10 held on the chuck table 71, an optical branching section 83 for guiding the light from the light source 82 to a first path 8a and also guiding reflected light from the wafer 10 through the first path 8a to a second path 8b, and the focusing means or condenser 81 for applying the light guided to the first path 8a to the wafer 10 held on the chuck table 71. The focusing means 81 includes a collimation lens 84 for collimating the light guided by the first path 8a and an objective lens 85 for focusing the light collimated by the collimation lens 84 and applying it to the wafer 10.

The light source 82 may, for example, be configured by a halogen lamp for emitting light having a wave length region of 400 to 1200 nm. The optical branching section 83 may be configured by a polarization maintaining fiber coupler, polarization maintaining fiber circulator, single-mode fiber coupler, or single-mode fiber coupler circulator. A path connecting the optical source 82 and the optical branching section 83 may be configured by an optical fiber. The first path 8a may also be configured by an optical fiber. The light source 82 is not limited to a halogen lamp described above, and any other light sources may be adopted according to the material of a wafer to be ground. That is, any light source may be suitably selected from known light sources capable of emitting light having a transmission wavelength to the wafer.

The second path 8b is provided with a collimation lens 86, a diffraction grating 87, a focusing lens 88, and an image sensor 89. The collimation lens 86 functions to collimate the reflected light obtained by the reflection from the upper surface of the LN substrate 11a of the wafer 10 held on the chuck table 71, the reflection from the lower surface of the LN substrate 11a, and the reflection from the lower surface of the SiO₂ film 11b of the wafer 10, and the next transmission through the objective lens 85, the collimation lens 84, and the first path 8a to the optical branching section 83 and the second path 8b. The diffraction grating 87 functions to diffract the reflected light collimated by the collimation lens 86 and then transmits diffracted light of different wavelengths through the focusing lens 88 to the image sensor 89. The image sensor 89 is what is generally called a line image sensor having a plurality of photodetectors arranged in a line. The image sensor 89 functions to detect the light intensity of the reflected light diffracted by the diffraction grating 87 according to different wavelengths and then transmits a detection signal to the control unit 100.

The control unit 100 is configured by a computer and includes a central processing unit (CPU) for performing computation according to a control program, a read only memory (ROM) previously storing the control program, a random access memory (RAM) which can read and write for temporarily storing detection values, computation results, etc., an input interface, and an output interface (the details of these components are not depicted). The detection signal transmitted from the image sensor 89 described above to the control unit 100 is converted into a spectral interference waveform, which is once stored into the RAM. As depicted in FIG. 2, the control unit 100 includes a thickness computing means 110 for outputting thickness information on the LN substrate 11a and on the SiO₂ film 11b according to the spectral interference waveform and a finished thickness setting section 120 for setting a target finished thickness of the LN substrate 11a to be ground. The thickness computing means 110 further includes a thickness calculating section 112 and a thickness deciding section 114. In this preferred embodiment, the control unit 100 controls not only the thickness measuring apparatus 8, but also all the other components including the driving sections and the imaging means in the grinding apparatus 1. As a modification, the control unit 100 may be used as a control unit dedicated to the control of the thickness measuring apparatus 8.

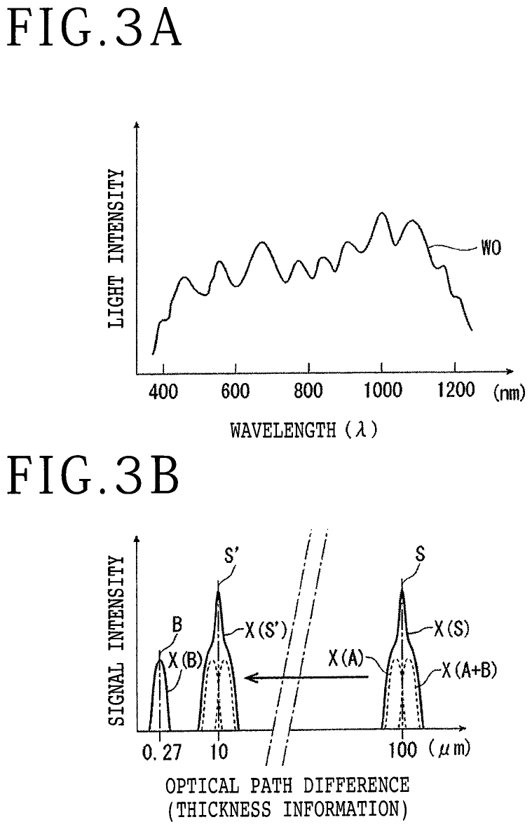

The thickness calculating section 112 functions to perform Fourier transform or the like to a spectral interference waveform W0 (see FIG. 3A) produced according to the detection signal transmitted from the image sensor 89, thereby performing waveform analysis. More specifically, the wafer 10 having a two-layer structure is held on the chuck table 71 in the condition where the LN substrate 11a becomes an upper layer (which will be hereinafter referred to as “A-layer”) and the SiO₂ film 11b becomes a lower layer (which will be hereinafter referred to a “B-layer”). The light emitted from the light source 82 is reflected on the upper surface and lower surface of the LN substrate 11a and on the lower surface of the SiO₂ film 11b. The reflected light from the wafer 10 is passed through the objective lens 85 and the collimation lens 84 of the focusing means 81 and through the first path 8a to reach the optical branching section 83. Then, the reflected light is guided from the optical branching section 83 to the second path 8b. The spectral interference waveform W0 is obtained from the reflected light. The waveforms of signal intensity illustrating the thicknesses of the A-layer, the B-layer, and the A-layer+the B-layer as depicted in FIG. 3B are output, and the optical path difference corresponding to a reflection position is determined from the position indicating the peak of each waveform. Finally, the thickness information on the A-layer (LN substrate 11a), the B-layer (SiO₂ film 11b), and the A-layer+the B-layer (LN substrate 11a+SiO₂ film 11b) is determined according to the optical path difference determined above.

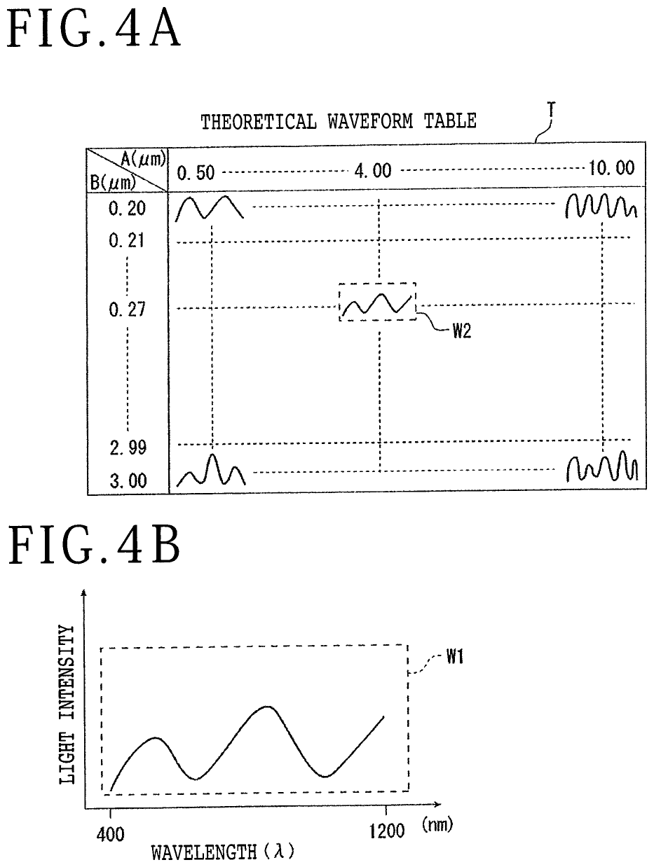

As depicted in FIG. 4A, the thickness deciding section 114 includes a theoretical waveform table T in which the shapes of various theoretical spectral interference waveforms to be formed by the pass of light through the A-layer and the B-layer constituting the wafer 10 are recorded in a plurality of areas defined by changing the thickness A of the A-layer (depicted by the horizontal axis) and the thickness B of the B-layer (depicted by the vertical axis) (only a part of the theoretical spectral interference waveforms is depicted in FIG. 4A for convenience of illustration). FIG. 4B depicts a spectral interference waveform W1 produced by a signal actually detected by the image sensor 89. In this case, the thickness deciding section 114 compares the spectral interference wave form W1 with the plural theoretical spectral interference waveforms recorded in the theoretical waveform table T.

When it is determined that the spectral interference waveform W1 coincides with any one of the plural theoretical spectral interference waveforms recorded in the theoretical waveform table T as a result of the abovementioned comparison (or the spectral interference waveform W is similar to any one of the plural theoretical spectral interference waveforms with the highest degree of coincidence), the value on the horizontal axis and the value on the vertical axis corresponding to this theoretical spectral interference waveform recorded in the theoretical waveform table T coinciding with the spectral interference waveform W1 are decided as the proper thicknesses of the A-layer and the B-layer. In this manner, the thicknesses of the A-layer and the B-layer constituting the wafer 10 can be determined. The plural theoretical spectral interference waveforms recorded in the plural areas defined in the theoretical waveform table T may be obtained by computer simulation.

The grinding apparatus 1 and the thickness measuring apparatus 8 according to this preferred embodiment are, in general, configured as described above. The operation of the grinding apparatus 1 including the thickness measuring apparatus 8 will now be described, where the LN substrate 11a of the wafer 10 is ground while measuring the thickness of the wafer 10 to thereby obtain the target finished thickness of the LN substrate 11a.

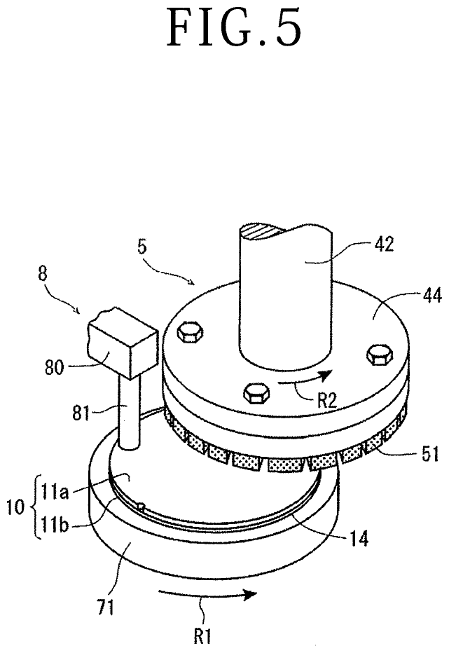

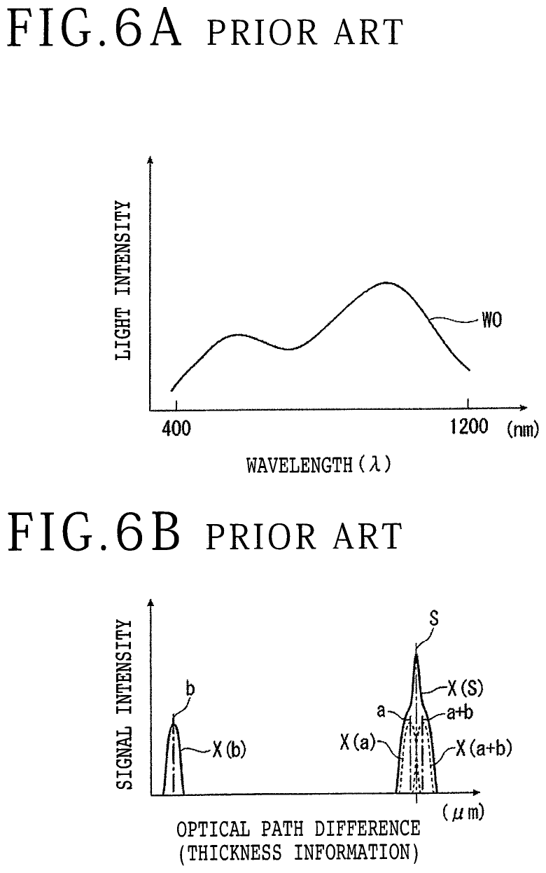

In performing the grinding operation, an operator uses an operation panel included in the grinding apparatus 1 to set the target finished thickness of the LN substrate 11a of the wafer 10 in the finished thickness setting section 120. For example, in the present embodiment, the target finished thickness of the A-layer (LN substrate 11a) is set to 4.00 μm. As depicted in FIG. 1, the protective tape 14 is attached to the front side of the wafer 10, where the devices 12 are previously formed on the front side of the A-layer and the B-layer (SiO₂ film 11b) is previously formed on the A-layer. Thereafter, the wafer 10 with the protective tape 14 attached thereto is inverted so that the protective tape 14 is oriented downward. Thereafter, the wafer 10 with the protective tape 14 is placed on the chuck table 71 set at the standby position 70a in the condition where the protective tape 14 is in contact with the upper surface of the chuck table 71. Thereafter, the suction means (not depicted) is operated to hold the wafer 10 through the protective tape 14 on the upper surface of the chuck table 71 under suction. Thereafter, the moving mechanism (not depicted) is operated to move the chuck table 71 from the standby position 70a to the grinding position 70b in the direction depicted by an arrow Xl in FIG. 1. Thereafter, as depicted in FIG. 5, the chuck table 71 is positioned so that the outer edges of the plural abrasive members 51 arranged annularly on the lower surface of the grinding wheel 5 pass through the center of rotation of the chuck table 71 as viewed in plan. Thereafter, the thickness measuring apparatus 8 is moved in the direction depicted by an arrow Xl to a thickness measuring position above the wafer 10 held on the chuck table 71.

In this manner, the grinding wheel 5 and the wafer 10 held on the chuck table 71 are set in position so as to keep the predetermined positional relation as mentioned above, and the thickness measuring apparatus 8 is also set at the thickness measuring position as mentioned above. Thereafter, the rotational drive means (not depicted) such as a motor is operated to rotate the chuck table 71 at a predetermined speed (e.g., 300 rpm) in the direction depicted by an arrow R1 in FIG. 5, and the servo motor 43 is operated to rotate the grinding wheel 5 at a predetermined speed (e.g. 6000 rpm) in the direction depicted by an arrow R2 in FIG. 5. Thereafter, the pulse motor 62 of the grinding unit feeding mechanism 6 is normally operated to lower (feed) the grinding wheel 5 until the plural abrasive members 51 come into abutment against the LN substrate 11a of the wafer 10 under a predetermined pressure. As a result, the back side of the LN substratella is ground (grinding step).

In the above grinding step, the thickness calculating section 112 of the control unit 100 is used to measure the thickness of the A-layer (upper layer) of the wafer 10 and the thickness of the B-layer (lower layer) of the wafer 10 in the condition where the wafer 10 is held on the chuck table 71. More specifically, the spectral interference waveform W0 depicted in FIG. 3A is obtained according to the detection signal transmitted from the image sensor 89. Thereafter, the thickness calculating section 112 performs Fourier transform or the like to the spectral interference waveform W0 to perform waveform analysis. As a result, a waveform X (B) of signal intensity and a waveform X (S) of signal intensity are obtained on the left side and the right side respectively, as depicted in FIG. 3B. Referring to FIG. 3B, the smallest optical path difference corresponding to the peak position of the waveform X (B) on the left side is 0.27 μm, which is the thickness of the B-layer, i.e., the thickness B of the SiO₂ film 11b.

On the right side in FIG. 3B, the waveform X (S) has a peak near 100 μm. This signal is obtained by synthesizing a waveform X (A) illustrating the thickness information on the A-layer and a waveform X (A+B) illustrating the thickness information on the A-layer+the B-layer, where the waveform X (A) and the waveform X (A+B) are depicted by broken lines. That is, since the thickness of the B-layer is much less than the thickness of the A-layer, the waveform X (A) and the waveform X (A+B) are synthesized to obtain the waveform X (S). The optical path difference S corresponding to the peak position of the waveform X (S) is not the thickness A of the A-layer in a strict sense. That is, the value S is slightly larger than the thickness A of the A-layer and slightly smaller than the thickness (A+B) of the A-layer and the B-layer. However, since the thickness of the B-layer is much less than the thickness of the A-layer, the value S is a rough thickness almost equal to the thickness of the A-layer, that is, slightly larger than the thickness of the A-layer.

During the grinding operation, it is constantly determined whether or not the abovementioned rough thickness S of the A-layer as obtained by the thickness calculating section 112 described above has reached a predetermined thickness range of the A-layer as set and recorded as the horizontal axis in the theoretical waveform table T included in the thickness deciding section 114. More specifically, as depicted in FIG. 4A, this predetermined thickness range of the A-layer recorded in the theoretical waveform table T is 0.50 to 10.00 μm. Accordingly, it is determined whether or not the rough thickness S of the A-layer as calculated by the thickness calculating section 112 describe above has reached 10 μm due to the grinding of the A-layer. As depicted in FIG. 3B, the thickness of the A-layer is reduced by grinding, so that the waveform X (S) before grinding is shifted to a waveform X (S′). When the rough thickness S′ of the A-layer obtained by the peak position of the waveform X (S′) has reached 10 μm due to grinding, it is at least determined that the actual thickness A of the A-layer after grinding has reached the predetermined thickness range of the A-layer as set as the horizontal axis in the theoretical waveform table T. In the case that the rough thickness S′ of the A-layer as calculated by the thickness calculating section 112 has not reached 10 μm, the grinding is continued.

As described above, after determining that the thickness A of the A-layer has reached the predetermined thickness range of the A-layer set as the horizontal axis in the theoretical waveform table T, the thickness computing means 110 continues to produce the spectral interference waveform W1 and compares the shape of the spectral interference waveform W1 (see FIG. 4B) with the shape of the theoretical spectral interference waveform recorded in each area of the theoretical waveform table T included in the thickness deciding section 114. Then, it is determined whether or not the spectral interference waveform W1 coincides with any one of the plural spectral interference waveforms recorded in the theoretical waveform table T. In other words, it is determined whether or not the phases of the two waveforms coincide. In the case that the shape of the spectral interference waveform W1 detected by the thickness calculating section 120 coincides with the shape of any one of the plural spectral interference waveforms recorded in the theoretical waveform table T, the thickness A and the thickness B corresponding to the theoretical spectral interference waveform coinciding with the spectral interference waveform W1 are decided as the proper thicknesses of the A-layer and the B-layer. Thereafter, it is determined whether or not the thickness A decided as the proper thickness of the A-layer has reached the target finished thickness (4.00 μm) of the A-layer. In the case that the thickness A has not reached the target finished thickness, the grinding is further continued.

The thickness computing means 110 compares the spectral interference waveform W1 produced by a signal detected by the image sensor 89 with a spectral interference waveform W2 (see FIG. 4A) corresponding to the target finished thickness (4.00 μm) of the A-layer as set in the finished thickness setting section 120, in which the spectral interference waveform W2 is one of the plural spectral interference waveforms recorded in the theoretical waveform table T. When the spectral interference waveform W1 coincides with the spectral interference waveform W2, it is determined that the thickness A of the A-layer (LN substrate 11a) has reached the target finished thickness (4.00 μm), and the grinding step is ended.

According to the above preferred embodiment, the thickness measuring apparatus 8 includes the thickness deciding section 114 to thereby exhibit the following effect in measuring the thickness of the wafer 10 having a two-layer structure composed of the LN substrate 11a (A-layer) as the upper layer and the SiO₂ film 11b (B-layer) as the lower layer, the thickness of the SiO₂ film 11b being much less than the thickness of the LN substrate 11a. A plurality of interference waves are produced by the diffraction grating 87 in the thickness measuring apparatus 8. The reflected light from the upper surface of the LN substrate 11a and the reflected light from the lower surface of the LN substrate 11a interfere with each other to produce an interference wave and accordingly obtain the thickness information on the LN substrate 11a. Further, the reflected light from the upper surface of the LN substrate 11a and the reflected light from the lower surface of the SiO₂ film 11b interfere with each other to produce another interference wave and accordingly obtain the thickness information on the LN substrate 11a+the SiO₂ film 11b. The thickness information on the LN substrate 11a is synthesized with the thickness information on the LN substrate 11a+the SiO₂ film 11b, so that there may be a problem that the thickness of the LN substrate 11a alone cannot be detected. However, this problem can be solved by using the thickness deciding section 114 for deciding the thickness of the LN substrate 11a. That is, the thickness of the LN substrate 11a alone can be measured.

Further, according to the grinding apparatus 1 including the thickness measuring apparatus 8 described above, the following effect can be exhibited. When the thickness of the A-layer (LN substrate 11a) reduced by grinding has reached the predetermined thickness range recorded in the theoretical waveform table T included in the thickness deciding section 114, the thickness computing means 110 compares the spectral interference waveform W1 produced by the image sensor 89 with the theoretical spectral interference waveform W2 recorded in the theoretical waveform table T, the waveform W2 corresponding to the target finished thickness of the A-layer as set in the finished thickness setting section 120. When the waveform W1 coincides with the waveform W2, it is determined that the thickness of the A-layer has reached the target finished thickness and the grinding operation is ended. Accordingly, even when the wafer 10 has a two-layer structure, the LN substrate 11a of the wafer 10 can be ground to obtain a desired finished thickness. Further, since the thickness measuring apparatus 8 is of a noncontact type in the above preferred embodiment, there is no possibility that the upper surface of the wafer 10 (the upper surface of the LN substrate 11a) may be damaged by the thickness measuring apparatus 8 in measuring the thickness of the wafer 10.

Furthermore, in the above preferred embodiment, the thickness range of the A-layer recorded in the theoretical waveform table T included in the thickness deciding section 114 is set to 0.5 to 10 μm, and the thicknesses of the A-layer and the B-layer are measured by using the thickness calculating section 112 and the thickness deciding section 114. However, the present invention is not limited to this configuration. For example, the thickness range of the A-layer recorded in the theoretical waveform table T included in the thickness deciding section 114 may be extended to a range covering an assumed thickness of the A-layer, e.g., 0.5 to 300 μm. In this case, the thicknesses of the A-layer and the B-layer of the wafer 10 can be measured only by the thickness deciding section 114 without using the thickness calculating section 112.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A thickness measuring apparatus for measuring the thickness of a wafer, said thickness measuring apparatus comprising:
a light source for emitting light having a transmission wavelength region to said wafer;
focusing means applying said light emitted from said light source to said wafer held on a chuck table, said wafer being composed of an A-layer as an upper layer and a B-layer as a lower layer in the condition where said wafer is held on said chuck table;
a first optical path for optically connecting said light source to said focusing means;
an optical branching section provided on said first optical path for branching said light reflected on said wafer held on said chuck table and then guiding said reflected light to a second optical path;
a diffraction grating provided on said second optical path for diffracting said reflected light to obtain diffracted light of different wavelengths;
an image sensor for detecting the intensity of said diffracted light according to said different wavelengths and producing a spectral interference waveform; and
a control unit having a thickness computing means computing said spectral interference waveform produced by said image sensor to output thickness information, wherein
said thickness computing means including a thickness deciding section having a theoretical waveform table in which a plurality of theoretical spectral interference waveforms to be formed by the pass of said light through said A-layer and said B-layer of said wafer are recorded in a plurality of areas defined by changing the thickness of said A-layer and the thickness of said B-layer, said thickness deciding section comparing said spectral interference waveform produced by said image sensor with said theoretical spectral interference waveforms recorded in said theoretical waveform table, determining whether or not said spectral interference waveform coincides with any one of said theoretical spectral interference waveforms, and deciding as proper thicknesses the thicknesses of said A-layer and said B-layer corresponding to said theoretical spectral interference waveform coinciding with said spectral interference waveform.

2. The thickness measuring apparatus according to claim 1, wherein
said thickness computing means further includes a thickness calculating section for performing Fourier transform to said spectral interference waveform produced by said image sensor and calculating at least the thickness of said A-layer, the thickness of said B-layer, and the thickness of said A-layer+said B-layer, said A-layer and said B-layer constituting the wafer.

3. The thickness measuring apparatus according to claim 2, wherein
when said thickness computing means determines that the thickness of said A-layer calculated by said thickness calculating section is included in the thickness range of said A-layer recorded in said theoretical waveform table of said thickness deciding section, the thickness of said A-layer decided as said proper thickness by said thickness deciding section is used as the thickness of said A-layer.

4. A grinding apparatus adapted to grind a wafer having an A-layer and a B-layer, said grinding apparatus comprising:
a chuck table for holding said wafer under suction in the condition where said A-layer becomes an upper layer and said B-layer becomes a lower layer;
a grinding unit having a plurality of abrasive members for grinding said A-layer of said wafer held on said chuck table by bringing said abrasive members into contact with said A-layer; and
a thickness measuring apparatus for measuring the thickness of said wafer;
said thickness measuring apparatus including:
a light source for emitting light having a transmission wavelength region to said wafer;
focusing means applying said light emitted from said light source to said wafer held on said chuck table;
a first optical path for optically connecting said light source to said focusing means;
an optical branching section provided on said first optical path for branching said light reflected on said wafer held on said chuck table and then guiding said reflected light to a second optical path;
a diffraction grating provided on said second optical path for diffracting said reflected light to obtain diffracted light of different wavelengths;
an image sensor for detecting the intensity of said diffracted light according to said different wavelengths and producing a spectral interference waveform; and
a control unit having a thickness computing means computing said spectral interference waveform produced by said image sensor to output thickness information;
said thickness computing means including a thickness deciding section having a theoretical waveform table in which a plurality of theoretical spectral interference waveforms to be formed by the pass of said light through said A-layer and said B-layer of said wafer are recorded in a plurality of areas defined by changing the thickness of said A-layer and the thickness of said B-layer, said thickness deciding section comparing said spectral interference waveform produced by said image sensor with said theoretical spectral interference waveforms recorded in said theoretical waveform table, determining whether or not said spectral interference waveform coincides with any one of said theoretical spectral interference waveforms, and deciding as proper thicknesses the thicknesses of said A-layer and said B-layer corresponding to said theoretical spectral interference waveform coinciding with said spectral interference waveform;
said control unit further including a finished thickness setting section for setting a target finished thickness of said A-layer, and
after the thickness of said A-layer calculated by said thickness calculating section has reached the thickness range of said A-layer recorded in said theoretical waveform table of said thickness deciding section, said thickness computing means compares said spectral interference waveform produced by said image sensor with said theoretical spectral interference waveform corresponding to said target finished thickness of said A-layer set by said finished thickness setting section, next determines whether or not said spectral interference waveform coincides with said theoretical spectral interference waveform, and next ends the grinding of said wafer when said spectral interference waveform coincides with said theoretical spectral interference waveform.
